(19) United States
(12) Patent Application Publication
(10) Pub. No.: US 2024/0311537 A1
(43) Pub. Date: Sep. 19, 2024

(54) Systems And Methods For Generating Redacted Circuit Designs For Integrated Circuits

(71) Applicant: Intel Corporation, Santa Clara, CA (US)

(72) Inventors: David Kehlet, Los Altos Hills, CA (US); Nij Dorairaj, Campbell, CA (US); Shuanghong Sun, Sunnyvale, CA (US)

(73) Assignee: Intel Corporation, Santa Clara, CA (US)

(21) Appl. No.: 18/120,857

(22) Filed: Mar. 13, 2023

(51) Int. Cl. G06F 30/31

(52) U.S. Cl. CPC G06F 30/31

(57) ABSTRACT

A computer system is provided for protecting an original circuit design for an integrated circuit. The computer system includes a logic circuit replacement tool that generates a redacted circuit design for the integrated circuit by replacing logic circuits in the original circuit design with first and second configurable circuits that perform logic functions of the logic circuits when a bitstream stored in storage circuits configures the first and the second configurable circuits. The logic circuit replacement tool couples one of the storage circuits that stores a bit in the bitstream to an input in each of the first and the second configurable circuits in the redacted circuit design.

### STATEMENT OF GOVERNMENT INTEREST

This Invention was made with Government support under Agreement No. N00164-19-9-0001, awarded by NSWC Crane Division. The Government has certain rights in the Invention.

### TECHNICAL FIELD

The present disclosure relates to electronic circuit systems and methods, and more particularly, to systems and methods for generating redacted circuit designs for integrated circuits.

### BACKGROUND OF THE INVENTION

Theft, reverse engineering, and piracy of intellectual property for hardware electronic circuits is a significant issue worldwide. Therefore, there is a need to protect designs for electronic circuits before and after manufacture and distribution. Hardware obfuscation is a method of modifying a design for an electronic circuit to generate an obfuscated design that is intended to be difficult to reverse engineer or copy. Traditional protection uses an obfuscator and a key that transforms the original design to the obfuscated design. The functionality of the original design can be determined by applying the correct key to the obfuscated design.

### BRIEF DESCRIPTION OF DRAWINGS

FIG. 1 illustrates an example of a redaction system that replaces logic circuits in a circuit design for an application specific integrated circuit (ASIC) with one or more configurable circuits that are configurable by one or more bitstreams.

FIG. 2 illustrates examples of configurable circuits in a redacted circuit design for an application specific integrated circuit (ASIC) that share bits in a bitstream.

FIG. 3 illustrates an example of a lookup table (LUT) circuit that has only one single select input that is responsive to only one single select signal.

FIG. 4A illustrates an example of a LUT circuit that includes 4 storage circuits and a multiplexer.

FIG. 4B illustrates an example of a LUT circuit that includes two storage circuits and a multiplexer circuit.

FIG. 5 illustrates an example of a LUT circuit that includes 4 storage circuits and a multiplexer that receives a reset signal at a select input.

FIG. 6 illustrates examples of two lookup table (LUT) circuits that share the same 4 configuration bits in a bitstream.

FIGS. 7A-7D illustrate examples of different possible configurable circuits that the redaction system can generate and/or select using one or more random numbers to replace one or more logic circuits in a circuit design for an ASIC.

### DETAILED DESCRIPTION

As discussed above, hardware obfuscation attempts to protect a design for an electronic integrated circuit (also referred to herein as a circuit design) by modifying the circuit design using a key to generate an obfuscated design that is intended to be difficult to reverse engineer without access to the key. However, if an untrusted party has access to an obfuscated design, it is possible that a determined attacker may be able to implement an attack that can discover the functionality of the original circuit design from the obfuscated design without having access to the key.

Many large system-on-chip (SOC) designs are built by assembling multiple intellectual property (IP) blocks on an integrated circuit. Some of the IP blocks may carry design secrets. It is important that these design secrets not be compromised by reverse engineering methods during the manufacturing and testing of the SOC.

In order to provide more secure protection of a circuit design for an application specific integrated circuit (ASIC) from discovery or reverse engineering, logic circuits in an original circuit design for an ASIC can be removed and replaced with one or more configurable circuits to generate a redacted circuit design, rather than merely obscuring an original circuit design in an integrated circuit using obfuscation. Thus, the original circuit design is redacted by replacing logic circuits in the original circuit design with configurable circuits, such as lookup tables, in the redacted circuit design. The configurable circuits in the redacted circuit design are configurable by one or more bitstreams to perform the same functions as the replaced logic circuits in the original circuit design. The ASIC is functional when the correct one or more bitstreams are loaded into the configurable circuits. The correct bitstream programs the configurable circuits to perform the same functions as the replaced logic circuits. The bitstream(s) function as a key that may, for example, be thousands of bits long. In contrast, the advanced encryption standard algorithm AES-256 uses a key that is only 256 bits long. Without the correct bitstream(s), the redacted circuit design will not function properly. The redacted circuit design cannot easily be reverse engineered. The routing wires within each configurable circuit and between the configurable circuits can, for example, be fixed and non-programmable or can be programmable.

The redacted circuit design is implemented, manufactured, and tested in a standard ASIC flow with the configurable circuits. During or after power-up of the ASIC in a system, one or more bitstreams are transmitted to and loaded into the ASIC, stored in the one or more configurable circuits, and configure the one or more configurable circuits to make the redacted circuit design functional during operation of the ASIC. When the one or more configurable circuits are configured by the one or more bitstreams, the redacted circuit design can implement the same functions as the original circuit design.

The one or more bitstreams are not stored in the ASIC after the ASIC is powered down. Instead, the one or more bitstreams are stored in a separate device and provided only to trusted parties and to the ASIC during power-up or reset. For example, the one or more bitstreams can be loaded into volatile memory from an external device at every power-up of the ASIC, and then when the ASIC is powered down, the volatile memory loses the bitstream values. The one or more bitstreams can be cryptographically protected during transfer, and then decrypted by the ASIC before being loaded into the configurable circuits.

Because the one or more bitstreams are not stored in the ASIC, an attacker cannot learn the functions of the original circuit design merely by having access to the ASIC. Anyone who has the ASIC, but not the bitstreams, cannot reconstruct the original circuit design or the functionality of the original circuit design. As an example, a facility that fabricates integrated circuits may have the physical design of an integrated circuit, the netlist of the physical design, and test vectors for the physical design. However, with the redaction system disclosed herein, the fabrication facility does not need to have access to the bitstreams, because the bitstreams are not needed for the fabrication or testing of the integrated circuit. Without access to the bitstreams, individuals at the fabrication facility are not able to reverse engineer the functions of the original circuit design of the integrated circuit. The ASIC can be tested by the facility without using the bitstreams. Rather, the ASIC is tested using test bitstreams that are unrelated to the bitstream of the redacted logic.

According to some examples disclosed herein, systems and methods are provided for compacting one or more bitstreams that are used for configuring configurable circuits in a redacted circuit design for an ASIC. The redacted circuit design is generated by replacing logic circuits in an original circuit design for the ASIC with the configurable circuits in the redacted circuit design, as described above. The one or more bitstreams can be compacted by sharing bits in the one or more bitstreams between multiple configurable circuits in the redacted circuit design. In these examples, two or more of the configurable circuits are configured by the same one or more bits in a bitstream. The bitstream is stored in storage circuits.

A redacted circuit design ideally uses a minimum amount of integrated circuit die area for the redaction to be practical for many ASIC circuit designs. Sharing bits in a bitstream between two or more configurable circuits as disclosed herein reduces the die area used in the ASIC for storing the bitstream. Thus, bitstream compaction and bit sharing between configurable circuits reduces the amount of die area required to fabricate the ASIC.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices. The term “circuit” may mean one or more passive and/or active electrical components that are arranged to cooperate with one another to provide a desired function.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

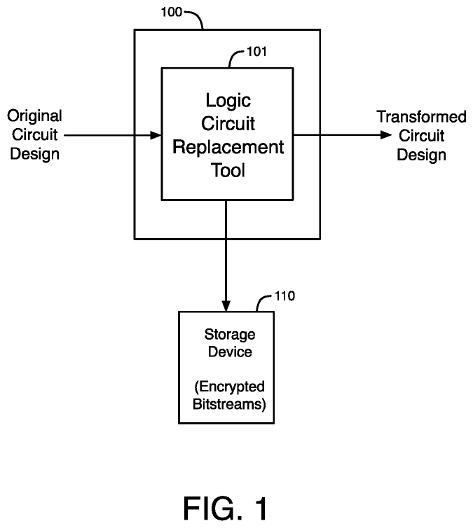

Figure (FIG. 1 illustrates an example of a redaction system 100 that replaces logic circuits in a circuit design for an application specific integrated circuit (ASIC) with configurable circuits that are configurable by one or more bitstreams to generate a redacted circuit design. Redaction system 100 includes a logic circuit replacement tool 101. Redaction system 100 can, for example, include one or more computer systems. The computer system(s) in redaction system 100 can include, for example, one or more processor circuits, storage/memory circuits, graphics processing circuits, programmable logic integrated circuits, input/output devices, and busses that connect these components together. Logic circuit replacement tool 101 can include computer hardware components and software tools that are implemented in one or more computer systems in redaction system 100. An original circuit design (also referred to herein as an original design) is provided to the redaction system 100 as shown in FIG. 1. The original design is a circuit design for at least a portion of (or all of) an electronic application specific integrated circuit (ASIC). The original circuit design is provided to logic circuit replacement tool 101.

The redaction system 100 redacts the intent of the original circuit design to generate a redacted circuit design for the ASIC using logic circuit replacement tool 101. Logic circuit replacement tool 101 transforms the original circuit design by replacing logic circuits in the original circuit design (e.g., critical logic circuits) with configurable circuits. The configurable circuits can, for example, include combinatorial circuits, such as lookup tables (LUTs). Tool 101 generates one or more bitstreams that can be stored in the configurable circuits and used to configure the configurable circuits to cause the configurable circuits to perform the logic functions of the logic circuits replaced in the original circuit design. The configurable circuits perform the same logic functions as the logic circuits replaced in the original circuit design when the one or more bitstreams are stored in the configurable circuits and used to configure the configurable circuits. The configurable circuits cannot perform the logic functions of the logic circuits replaced in the original design without access to the one or more bitstreams. Redaction system 100 can replace the logic circuits with configurable circuits prior to synthesis and physical implementation of the circuit design.

The logic circuit replacement tool 101 removes the logic circuits in the original circuit design and replaces the removed logic circuits with configurable circuits that perform the same logic functions as the removed logic circuits when one or more bitstreams are stored in the configurable circuits and used to configure the configurable circuits. As examples, the configurable circuits can be lookup-tables (LUTs) that perform combinatorial logic functions. Tool 101 can vary the number of logic circuits removed in the original circuit design and replaced with configurable circuits based on the complexity of the original circuit design. As an example, tool 101 can only replace a small fraction (e.g., 10-30%) of the original circuit design with configurable circuits configurable by one or more bitstreams.

The bitstreams can be cryptographically protected. The bitstreams are provided only to trusted parties to prevent unauthorized access to the original circuit design. The bitstreams are initially not stored in the ASIC containing the configurable circuits. Instead, the bitstreams (e.g., an encrypted version of the bitstreams) are transferred to and stored in an external storage device 110, as shown in FIG. 1. Only an authorized party who has access to the bitstreams can provide the bitstreams from the storage device 110 to the ASIC for storage in the configurable circuits.

A party who has access to the ASIC, but not the bitstreams, cannot reconstruct the original circuit design. For example, an integrated circuit fabrication facility may have a physical circuit design, a netlist, and test vectors for the circuit design for an ASIC. With the system of FIG. 1, the fabrication facility does not need access to the bitstreams, because the bitstreams are not needed for fabrication or testing of the ASIC. Without the bitstreams, the original circuit design is not available to a potential attacker at the fabrication facility. In some examples, an additional verification process can be performed after logic circuit replacement tool 101 generates the redacted circuit design to ensure that the function of the original circuit design can be reproduced by applying the bitstreams to the redacted circuit design.

During operation, executable software, such as the software of logic circuit replacement tool 101, runs on the processor(s) of redaction system 100. Databases can be used to store data for the operation of system 100. In general, software and data can be stored in non-transitory computer readable storage media (e.g., tangible computer readable storage media). The software may sometimes be referred to as software, data, program instructions, instructions, or code. The non-transitory computer readable storage media can include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s). Software stored in the non-transitory computer readable storage media can be executed in redaction system 100. When the software of redaction system 100 is installed, the storage of redaction system 100 has instructions and data that cause the computing equipment in redaction system 100 to execute various methods (processes). When performing these processes, the computing equipment is configured to implement the functions of redaction system 100.

In an application specific integrated circuit (ASIC), a fabric of lookup table (LUT) circuits can be built for a circuit design for the ASIC. The fabric of LUT circuits can offer the flexibility of choosing an optimal circuit structure that uses less die area and has increased performance over a programmable logic integrated circuit based on the circuit design constraints. As discussed above, one or more bitstreams used to configure configurable circuits in a redacted circuit design can be compacted by sharing bits in the one or more bitstreams between the configurable circuits. In these examples, two or more of the configurable circuits are configured by the same one or more bits in a bitstream during operation in order to reduce the die area of the redacted circuit design.

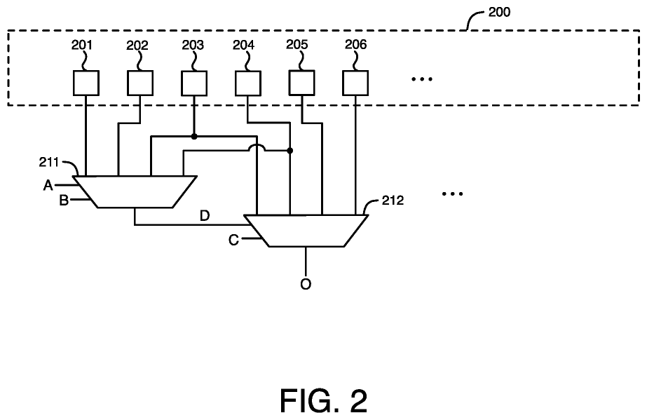

FIG. 2 illustrates examples of configurable circuits in a redacted circuit design for an application specific integrated circuit (ASIC) that share bits in a bitstream. In the example of FIG. 2, redaction system 100 of FIG. 1 compacts and shares two bits in a bitstream between two LUT circuits. FIG. 2 illustrates 6 storage circuits 201-206 and 2 multiplexer circuits 211-212. The 6 storage circuits 201-206 shown in FIG. 2 can be, as examples, flip-flop circuits or memory circuits, such as random access memory (RAM) circuits.

The redacted circuit design of FIG. 2 includes several configurable lookup table (LUT) circuits. Two of the LUT circuits in the redacted circuit design are shown in FIG. 2. The first LUT circuit shown in FIG. 2 includes a multiplexer circuit 211 and four storage circuits 201-204. The second LUT circuit shown in FIG. 2 includes a multiplexer circuit 212 and four storage circuits 203-206. Thus, the first and second LUT circuits shown in FIG. 2 share the two storage circuits 203 and 204. Storage circuits 201-204 are coupled to 4 data inputs of multiplexer circuit 211, and storage circuits 203-206 are coupled to 4 data inputs of multiplexer circuit 212.

The storage circuits 201-206, and additional storage circuits not shown in FIG. 2, store a bitstream that configures the LUT circuits in the redacted circuit design, including the 2 LUT circuits shown in FIG. 2. The 6 storage circuits 201-206 store 6 bits in the bitstream. The 4 bits in the bitstream stored in storage circuits 201-204 are provided to the 4 data inputs of the multiplexer circuit 211. The 4 bits in the bitstream stored in storage circuits 203-206 are provided to the 4 data inputs of the multiplexer circuit 212. Thus, the two bits in the bitstream that are stored in the storage circuits 203-204 are shared between the multiplexer circuits 211-212, and thus are shared between the two LUT circuits of FIG. 2.

Sharing the two bits stored in storage circuits 203-204 between the two LUT circuits of FIG. 2 eliminates the need to store a copy of each of these 2 bits in each of the two LUT circuits, eliminating the storage of duplicate bits (i.e., eliminating 2 storage circuits). Also, the storage circuits 203-204 are shared between the multiplexer circuits 211-212, and thus are shared between the two LUT circuits of FIG. 2. Sharing storage circuits 203-204 between the two LUT circuits in FIG. 2 reduces the die area in the ASIC used for storing the bitstream, because a total of only two storage circuits 203-204 are used to store the shared bits, rather than using 2 storage circuits in each LUT circuit to store the 2 bits (i.e., using a total of 4 storage circuits).

Two select signals A and B are provided to 2 select inputs of multiplexer circuit 211. A select signal C and the output signal D of multiplexer circuit 211 are provided to 2 select inputs of multiplexer circuit 212, which generates an output signal O. Multiplexer circuit 211 selects a bit from one of the storage circuits 201-204 based on the values of the select signals A-B and provides the value of the selected bit to its output as output signal D. Multiplexer circuit 212 selects a bit from one of the storage circuits 203-206 based on the values of the select signals C-D and provides the value of the selected bit to its output as output signal O.

FIG. 2 discloses merely one example of how bits in a bitstream can be compacted and shared by multiple LUT circuits in a redacted circuit design for an ASIC. According to other examples, redaction system 100 of FIG. 1 can compact and share any number of bits in a bitstream between two or more configurable circuits in a redacted circuit design for an ASIC. The shared bits in the bitstream are used for configuring the configurable circuits. As additional examples, two bits in a bitstream can be compacted and shared between two, three, four, five, six, or more configurable circuits (e.g., LUT circuits) in a redacted circuit design for an ASIC. As other examples, three, four, five, six, or more bits in a bitstream can be compacted and shared between two, three, four, five, six, or more configurable circuits (e.g., LUT circuits) in a redacted circuit design for an ASIC. The shared bits in the bitstream in each of these examples are stored in storage circuits in the ASIC and used to configure the two, three, four, five, six, or more configurable circuits in the redacted circuit design for the ASIC.

In some implementations, using bitstream compaction and bit sharing in a bitstream for a redacted circuit design may reduce the solution space for the redacted circuit design. Reducing the solution space for a redacted circuit design may make the redacted circuit design easier to reverse engineer. According to various techniques disclosed herein, the redaction system 100 can apply rules during the generation of a redacted circuit design for an ASIC that prevent or mitigate the reduction of the solution space of the redacted circuit design that would otherwise occur by applying bitstream compaction and bit sharing in a bitstream, as disclosed above. Examples of 5 bitstream compaction rules are described below that redaction system 100 can apply during the generation of a redacted circuit design for an ASIC to prevent or decrease reduction of the solution space and to prevent the redacted circuit design from being detected. According to various examples, the redaction system 100 can apply any one or more of these 5 bitstream compaction rules during the generation of a redacted circuit design for an ASIC to make the redacted circuit design more difficult to reverse engineer.

According to the first bitstream compaction rule, redaction system 100 refrains from replacing any logic circuit or logic circuits in an original circuit design for an ASIC with a lookup table (LUT) circuit that has only one single select input that is responsive to only one single select signal. For the 5 exemplary bitstream compaction rules disclosed herein, a select input is an input of a LUT circuit (e.g., a select input of a multiplexer in the LUT circuit) that can receive a select signal, and the LUT circuit selects a bit from a bitstream stored in a storage circuit based on the value of the select signal received at its select input.

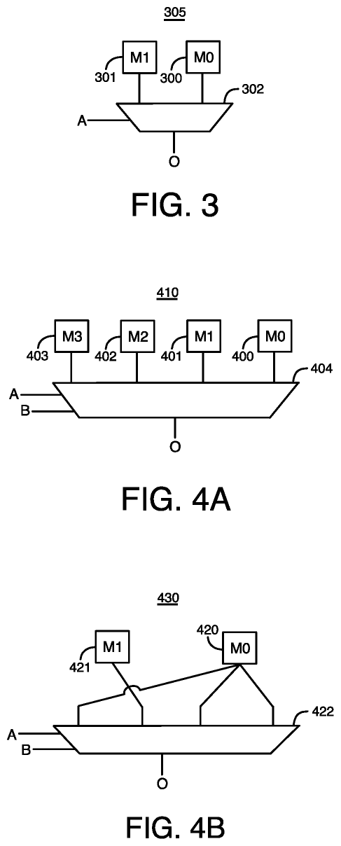

FIG. 3 illustrates an example of a lookup table (LUT) circuit that has only one single select input that is responsive to only one single select signal. The LUT circuit 305 shown in FIG. 3 includes a multiplexer circuit 302 and storage circuits 300 and 301 that store bits M0 and M1, respectively, in a bitstream. The bits M0 and M1 are provided from storage circuits 300-301 to data inputs of multiplexer circuit 302. A single select signal A is provided to a single select input of multiplexer circuit 302. Multiplexer circuit 302 selects a bit MO or M1 from one of the storage circuits 300-301 based on the value of the select signal A and provides the value of the selected bit to its output as output signal O.

If the redaction system 100 is programmed to include additional rules that prevent replacement of any logic circuit in an original circuit design with a LUT circuit that outputs a constant logic value or a LUT circuit that outputs the same logic value as the logic value of the select signal received by the LUT circuit, then the LUT circuit 305 of FIG. 3 can only be an inverter that causes output signal O to have the opposite logic value of the logic value of the select signal A. Because LUT circuit 305 can only be an inverter using these additional rules, the first bitstream compaction rule prevents the redaction system 100 from replacing any logic circuit or circuits in an original circuit design for an ASIC with a LUT circuit that has only one single select input that is responsive to only one single select signal, such as LUT circuit 305.

According to the second bitstream compaction rule, redaction system 100 refrains from sharing multiple bits in a bitstream within a single LUT circuit in a redacted circuit design for an ASIC. For example, redaction system 100 does not create a LUT circuit in which a single bit stored in a single storage circuit is provided to two or more data inputs of the multiplexer circuit in the LUT circuit. Thus, two or more bits in a bitstream cannot be shared within a single LUT circuit according to the second bitstream compaction rule. The second bitstream compaction rule is selected to prevent redaction system 100 from creating a LUT circuit in a redacted circuit design that has a substantially reduced solutions space.

FIG. 4A illustrates an example of a LUT circuit 410 that includes 4 storage circuits 400-403 and a multiplexer 404. Each of the 4 data inputs of multiplexer circuit 404 is coupled to a different one of the storage circuits 400-403. Storage circuits 400-403 store 4 configuration bits M0-M3 in a bitstream for configuring LUT circuit 410 during operation of the ASIC. Multiplexer circuit 404 is configurable to provide the value of the bit from one of the storage circuits 400-403 that is selected based on the values of the select signals A-B to its output as output signal O. The second bitstream compaction rule described above prevents the redaction system 100 from sharing bits within a LUT circuit. Thus, the second bitstream compaction rule requires that each configuration bit used to configure a LUT circuit in a redacted circuit design for an ASIC be a unique configuration bit stored in a unique storage circuit, as with the example of LUT circuit 410.

FIG. 4B illustrates an example of a LUT circuit 430 that includes two storage circuits 420-421 and a multiplexer circuit 422. The two storage circuits 420 and 421 in LUT circuit 430 store two configuration bits MO and M1, respectively, in a bitstream. Bit M1 is provided from storage circuit 421 to one data input of multiplexer circuit 422, and bit MO is provided from storage circuit 420 to three data inputs of multiplexer circuit 422. Because a single configuration bit MO is shared between three different data inputs of multiplexer circuit 422 within LUT circuit 430, the second bitstream compaction rule prevents redaction system 100 from replacing any one or more logic circuits in an original circuit design with LUT 430 in the redacted circuit design.

If the redaction system 100 is programmed to include additional rules that prevent the replacement of any logic circuit in an original circuit design with a LUT circuit that outputs a constant logic value or with a LUT circuit that generates an output signal having a logic value that depends on the logic value of only one select signal, then redaction system 100 can generate a LUT circuit 410 (FIG. 4A) that only uses 10 combinations of the configuration bits M0-M3, out of 16 possible combinations of the configuration bits M0-M3. Thus, these additional rules reduce the solution space for LUT circuit 410 from 16 possible combinations of the configuration bits M0-M3 to 10 possible combinations. Sharing configuration bit M0 within LUT circuit 430 as shown in FIG. 4B further reduces the combinations of the configuration bits in LUT circuit 430 that are used to only two possible combinations of M0 and M1 (i.e., 01 or 10), which undesirably reduces the solution space.

The third bitstream compaction rule applies when the redaction system 100 is mapping a reset signal to the select input of a lookup table (LUT) circuit in a redacted circuit design for an ASIC. According to the third bitstream compaction rule, redaction system 100 refrains from using bitstream compaction on the configuration bits used to configure a LUT circuit that receives a reset signal (e.g., from a reset network) at one of its select inputs. According to the third bitstream compaction rule, none of the configuration bits used to configure a LUT circuit that receives a reset signal at one of its select inputs can be shared with another LUT circuit in the redacted circuit design. The third bitstream compaction rule can be used to prevent further reduction of the solution space of a redacted circuit design if the redaction system 100 is programmed to allow mapping a reset signal to the select input of a LUT circuit in the redacted circuit design.

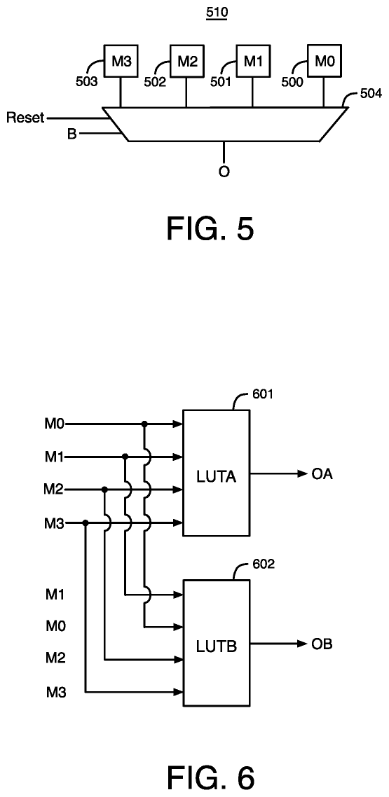

FIG. 5 illustrates an example of a LUT circuit 510 that includes 4 storage circuits 500-503 and a multiplexer circuit 504. Each of the 4 data inputs of multiplexer circuit 504 is coupled to a different one of the storage circuits 500-503. Storage circuits 500-503 store 4 configuration bits M0-M3, respectively, in a bitstream that configure LUT circuit 510 during operation of the ASIC. Multiplexer circuit 504 receives 2 select signals Reset and B at its 2 select inputs. Multiplexer circuit 504 selects a configuration bit from one of storage circuits 500-503 based on the values of the select signals (Reset and B) and provides the value of the selected bit to its output as output signal O.

In the example of FIG. 5, the third bitstream compaction rule described above prevents the redaction system 100 from using bitstream compaction on any of the configuration bits M0-M3 stored in storage circuits 500-503, respectively, because multiplexer circuit 504 receives a Reset signal at one of its select inputs. The third bitstream compaction rule prevents any of the configuration bits M0-M3 stored in storage circuits 500-503 from being shared with another LUT circuit in the redacted circuit design. Thus, the configuration bits M0-M3 stored in storage circuits 500-503 are only provided to data inputs of multiplexer circuit 504, and not to inputs of any other LUT circuits (or other configurable circuits) in the redacted circuit design. In addition, the storage circuits 500-503 are not coupled to the data inputs of multiplexer circuits in any other LUT circuits.

In a 2-input LUT circuit that receives a reset signal at one of its 2 select inputs, such as LUT circuit 510, the reset signal can be presumed to override the other select signal (e.g., signal B in FIG. 5), as the typical usage of a reset function. In this example, if the reset signal is 1, then the LUT circuit outputs 0 or 1, and if the reset signal is 0, then the LUT circuit outputs the logic value of the other select signal or the logically inverted value of the other select signal (e.g., B or B! in LUT circuit 510). As a result, the number of used combinations of the 4 configuration bits for the 2-input LUT circuit in this example is reduced to only 4 combinations, without any bitstream compaction. Sharing any of the 4 configuration bits (e.g., bits M0-M3 in LUT 510) with another LUT circuit in the circuit design may reduce the number of combinations of the configuration bits used by either LUT circuit (e.g., possibly to one combination). Therefore, the redaction system 100 implements the third bitstream compaction rule to prevent any of the configuration bits provided to a LUT circuit that receives a reset signal from being shared with (i.e., provided to inputs of) another LUT circuit in the redacted circuit design. The third bitstream compaction rule also makes the redacted circuit design more difficult to discover or reverse engineer.

According to the fourth bitstream compaction rule, redaction system 100 replaces logic circuits in an original circuit design for an ASIC with larger lookup table (LUT) circuits when possible to create a larger bitstream solution space in the redacted circuit design. Larger LUT circuits can generate output signals that are based on a larger number of candidate combinations of their input configuration bits than smaller LUT circuits. Larger LUT circuits can also generate output signals that are based on a larger percentage of candidate combinations of their input configuration bits than smaller LUT circuits. Therefore, larger LUT circuits have a larger bitstream solution space than smaller LUT circuits and are more difficult to reverse engineer (e.g., by a brute force attack).

For example, a LUT circuit that has 3 select inputs can generate 256 possible combinations of its 8 input configuration bits, with 218 out of these 256 possible combinations being candidate combinations that generate usable outputs. A LUT circuit that has 2 select inputs can generate 16 possible combinations of its 4 configuration bits, with 10 out of these 16 possible combinations being candidate combinations that generate usable outputs. According to the fourth bitstream compaction rule, redaction system 100 can replace one or more logic circuits in an original circuit design for an ASIC with a LUT circuit having 3, 4, 5, or more select inputs, rather than multiple LUT circuits each having 2 select inputs.

According to the fifth bitstream compaction rule, redaction system 100 compacts configuration bits in a bitstream only in the same order for multiple LUT circuits that share the same configuration bits. The fifth bitstream compaction rule prevents a candidate combination of configuration bits eliminated from one LUT circuit from overlapping with the possible candidate combinations of the configuration bits for another LUT circuit. Thus, the redaction system 100 refrains from permuting the order of the configuration bits in a bitstream when the same configuration bits are shared with multiple LUT circuits in a circuit design for an ASIC. An example of a LUT circuit configuration that the fifth bitstream compaction rule prevents from being created in a circuit design is disclosed herein with respect to FIG. 6.

FIG. 6 illustrates examples of two lookup table (LUT) circuits 601-602 that share the same 4 configuration bits in a bitstream. LUT circuits 601-602 generate output signals OA and OB, respectively, based on configuration bits M0-M3 and select signals (not shown). In the example of FIG. 6, the four configuration bits M0-M3 in the bitstream are provided to 4 data inputs of each of the 2 LUT circuits 601 and 602. The configuration bits are provided to the data inputs of LUT circuit 601 in a first order of M0, M1, M2, and M3. The configuration bits are provided to the data inputs of LUT circuit 602 in a second order of M1, M0, M2, and M3. The fifth bitstream compaction rule prevents redaction system 100 from replacing one or more logic circuits in an original circuit design for an ASIC with the configuration of LUT circuits 601-602 shown in FIG. 6, because the second order of the configuration bits M0-M3 is different than the first order.

Without applying the fifth bitstream compaction rule, eliminated candidate combinations of the configuration bits M0-M3 that cannot be used for LUT circuit 601 (e.g., because of other rules) also cannot be used as candidate combinations of the configuration bits M0-M3 for LUT circuit 602, because the configuration bits M0-M3 are shared between LUT circuits 601-602. As a result, LUT circuit 602 may have its possible candidate combinations of the configuration bits reduced from 10 to only 8 candidate combinations that generate usable outputs. Thus, without applying the fifth bitstream compaction rule, the solution space for LUT circuits 601-602 would be undesirably reduced.

An attacker may desire to discover the intellectual property (IP) redacted from an original circuit design for an ASIC through examination of a redacted circuit design for the ASIC. If an attacker can match a candidate original circuit design to the redacted circuit design with certainty, the original function of the redacted circuit design can be revealed. An attacker may attempt to match a candidate original circuit design to a redacted circuit design by using the redaction system 100 on the candidate original circuit design.

As discussed above, redaction systems and methods are provided for replacing logic circuits in an original circuit design for an ASIC with configurable circuits in a redacted circuit design for the ASIC. According to additional examples disclosed herein, a redaction system can use one or more random numbers to generate and/or select among different possible configurable circuits to replace logic circuits that are in the original circuit design. The random numbers can be generated, for example, with a pseudo random number generator (PRNG) using a key. The redaction system can, for example, generate multiple different possible configurable circuits using the random numbers for each logic circuit or each set of logic circuits to be replaced in the original circuit design. The redaction system can also, for example, use the random numbers to select one of the different possible configurable circuits to replace each logic circuit or each set of logic circuits to be replaced in the original circuit design. Each of the different possible configurable circuits performs the same logic functions as the logic circuit(s) to be replaced in the original circuit design.

The redaction system uses key-based variation that is based on random numbers to guide decisions on how to replace the logic circuits with the different possible configurable circuits. Generating different possible configurable circuits provides an additional level of design secrecy protection for the redacted circuit design in addition to the logic redaction techniques of FIG. 1. Providing different possible configurable circuits for each logic circuit or each set of logic circuits to be replaced in the original circuit design prevents an attacker from merely running a candidate original circuit design through the redaction system and comparing the output of the redaction system to the redacted circuit design. In a brute force attack, an attacker can attempt to configure the redacted circuit design with a selected combination of bits in the bitstream. In another type of attack, an attacker compares the redacted circuit design in question to a list of candidate circuit designs. If the attacker redacts each circuit design in the list using the redaction system, and a result matches the redacted circuit design in question, then the attacker will have learned the function of the original circuit design. Generating and/or selecting among different possible configurable circuits using random numbers makes it more difficult for an attacker to achieve certainty that a candidate original circuit design was used to produce the redacted circuit design.

According to these examples, the redaction system generates options of different possible configurable circuits that can replace each logic circuit or each set of logic circuits to be replaced in the original circuit design for the ASIC. The redaction system can generate the options of the different possible configurable circuits for the same logic circuit(s) by using variation, for example, that is based on random numbers. The options for generating the different possible configurable circuits can include, for example, using weighting for selecting different lookup table (LUT) circuit sizes (e.g., LUTs having 2, 3, or 4 select inputs) to replace logic circuits in the original circuit design using random numbers. Another option for generating the different possible configurable circuits can include generating different connections of LUT circuits to form a logic cone using random numbers. A logic cone is a block of combinatorial logic circuits with one or more inputs that produces a single logic output signal.

Another option for generating the different possible configurable circuits includes inserting flops (FF) circuits that are not in the original circuit design into one or more of the different possible configurable circuits using random numbers. Another option for generating the different possible configurable circuits includes selecting and inserting additional connections between circuits into a logic cone in one or more of the different possible configurable circuits using random numbers. Yet another option for generating the different possible configurable circuits includes selecting and inserting additional inputs and outputs into one or more of the different possible configurable circuits using random numbers. As yet another option for generating the different possible configurable circuits, the redaction system can insert multiplexers that were not in the original circuit design into one or more of the different possible configurable circuits using random numbers. Thus, one or more of the different possible configurable circuits generated by the redaction system may use unneeded circuitry, and are therefore less space efficient in terms of die area usage in the ASIC.

As still another option for generating the different possible configurable circuits, the redaction system can vary the width of the multiplexers in one or more of the different possible configurable circuits using random numbers. As still another option for generating the different possible configurable circuits, the redaction system can generate connections that bypass flip-flop circuits in one or more of the different possible configurable circuits using random numbers. As still another option for generating the different possible configurable circuits, the redaction system can couple the output of a flip-flop circuit to the input logic cone of the flip-flop circuit in one or more of the different possible configurable circuits using random numbers.

In these examples, the variation used to generate and/or select the different possible configurable circuits can be provided by a pseudorandom number generator (PRNG) that generates the random numbers. If a PRNG is used with a key (also referred to as a seed), the PRNG creates the same bit sequence in each random number every run for reproducibility. A cryptographically strong PRNG can be used that creates a bit sequence in each random number that is not predictable without the key due to brute force computational limits. The PRNG key is kept secret and is not available to the attacker. A redacted circuit design for an ASIC provides design secrecy, in that the function of the original circuit design cannot be reverse engineered from the redacted circuit design. These examples that generate options for different possible configurable circuits provide an additional level of design secrecy protection by removing information about a data flow and data storage elements in the original circuit design.

An example of a PRNG that redaction system 100 can use to generate and/or select different possible configurable circuits for replacing logic circuits in an original circuit design for an ASIC is disclosed with respect to the following algorithm. This algorithm is provided merely as an example and is not intended to be limiting. In this algorithm, x0, key, d0, d1, d2 are N-bit vectors, and N=384 is a typical size that matches a hashing function, such as SHA-384. The function hash(x) is a hashing function, such as SHA-384. The three random numbers d0, d1, and d2 shown below can be generated using this algorithm. This algorithm can also be used to generate as many random numbers as needed by the redaction system 100.
x0=0^key; d0=hash(x0); use d0 as the random number
x1=d0^key; d1=hash(x1); use d1 as the random number
x2=d1^key; d2=hash(x2); use d2 as the random number

Each random number generated by the PRNG can be wrapped in a function that only uses the number of bits needed to satisfy a decision. For example, if the redaction system 100 at any time needs to select one of 24 alternatives of possible configurable circuits, the function around the PRNG may return 5 bits, and conserve the remaining bits in the 384 bit random number for future function calls. Without the key, an attacker cannot determine where in the 384 bits the 5 bits are selected from.

Redaction system 100 can use the random numbers generated by the PRNG to generate and/or select from multiple different possible configurable circuits to replace each logic circuit or set of logic circuits to be replaced in a circuit design for an ASIC. Without access to the key used to generate the random numbers, the redaction system 100 cannot identify the original circuit design from the redacted circuit design. As an example, if the PRNG generates 256 possible random numbers, redaction system 100 can generate 256 possible original circuit designs that correspond to the redacted circuit design without the key, and an attacker would not be able to determine which of these circuit designs is the secret original circuit design.

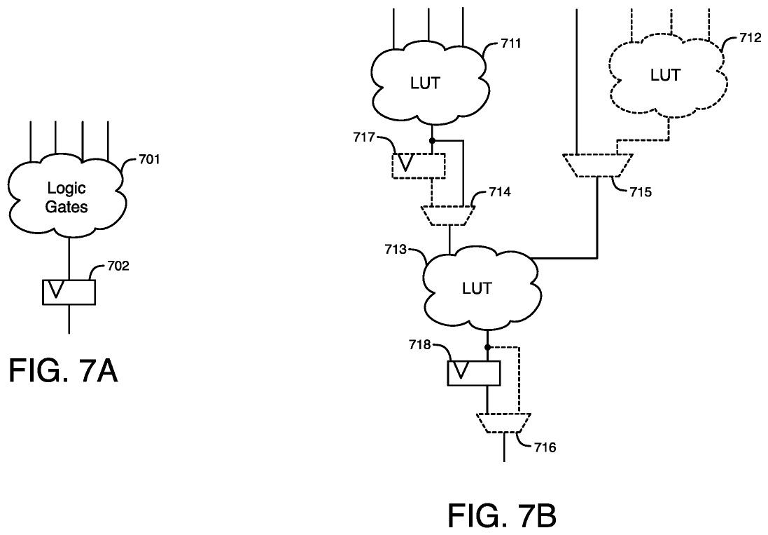

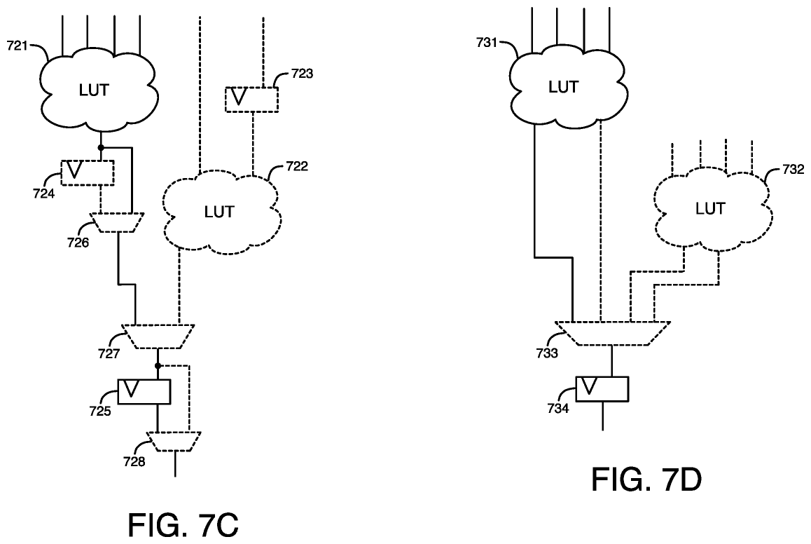

FIGS. 7A-7D illustrate examples of different possible configurable circuits that redaction system 100 can generate and/or select using one or more random numbers to replace one or more logic circuits in an example of an original circuit design for an ASIC. FIG. 7A is a diagram of the original circuit design for the ASIC. The original circuit design for the ASIC includes logic gates 701 that have 4 inputs and an output coupled to a register 702. The register 702 generates an output signal at its output based on the output signal of logic gates 701.

FIG. 7B is a diagram that illustrates a first example of a configurable circuit that the redaction system 100 can generate and/or select as a possible replacement for the logic gates 701 and register 702 in the original circuit design. The configurable circuit shown in FIG. 7B includes 3 LUT circuits 711-713, 3 multiplexer circuits 714-716, and 2 register circuits 717-718. The circuits 712, 714-716, and 717 and the wires depicted with dotted lines in FIG. 7B are circuits and wires that are not in the original circuit design for the ASIC. The redaction system 100 adds circuits 712, 714-716, and 717 to the configurable circuit of FIG. 7B to generate and/or select an additional configurable circuit that can be a possible replacement for the logic circuits of FIG. 7A using one or more random numbers. If redaction system 100 chooses to replace the logic circuits of FIG. 7A with the configurable circuit of FIG. 7B, redaction system 100 configures multiplexer circuit 714 to always bypass register circuit 717, configures multiplexer circuit 715 to always bypass LUT circuit 712, and configures multiplexer circuit 716 to always provide the value of the output signal of register circuit 718 to the output of multiplexer circuit 716. As a result, the configurable circuit of FIG. 7B performs the same logic functions as the logic gates 701 and register 702 of FIG. 7A.

FIG. 7C is a diagram that illustrates a second example of a configurable circuit that the redaction system 100 can generate and/or select as a possible replacement for the logic gates 701 and register 702 in the original circuit design. The configurable circuit shown in FIG. 7C includes 2 LUT circuits 721-722, 3 register circuits 723-725, and 3 multiplexer circuits 726-728. The circuits 722, 723-724, and 726-728 and the wires depicted with dotted lines in FIG. 7C are circuits and wires that are not in the original circuit design. The redaction system 100 adds circuits 722-724 and 726-728 to the configurable circuit of FIG. 7C to generate and/or select an additional configurable circuit that can be a possible replacement for the logic circuits of FIG. 7A using one or more random numbers. If redaction system 100 chooses to replace the logic circuits of FIG. 7A with the configurable circuit of FIG. 7C, redaction system 100 configures multiplexer circuit 726 to always bypass register circuit 724, configures multiplexer circuit 727 to always bypass LUT circuit 722 and register circuit 723, and configures multiplexer circuit 728 to always provide the value of the output signal of register circuit 725 to the output of multiplexer circuit 728. As a result, the configurable circuit of FIG. 7C performs the same logic functions as the logic gates 701 and register 702 of FIG. 7A.

FIG. 7D is a diagram that illustrates a third example of a configurable circuit that the redaction system 100 can generate and/or select as a possible replacement for the logic gates 701 and register 702 in the original circuit design. The configurable circuit shown in FIG. 7D includes 2 LUT circuits 731-732, a register circuit 734, and a multiplexer circuit 733. The circuits 732 and 733 and the wires depicted with dotted lines in FIG. 7D are circuits and wires that are not in the original circuit design. The redaction system 100 adds circuits 732-733 to the configurable circuit of FIG. 7D to generate and/or select an additional configurable circuit that can be a possible replacement for the logic circuits of FIG. 7A using one or more random numbers. If the redaction system 100 chooses to replace the logic circuits of FIG. 7A with the configurable circuit of FIG. 7D, redaction system 100 configures multiplexer circuit 733 to always bypass LUT circuit 732 and to always select the output signal of LUT circuit 731. As a result, the configurable circuit of FIG. 7D performs the same logic functions as the logic gates 701 and register 702 of FIG. 7A.

The ASICs disclosed herein can be designed to implement any suitable type of integrated circuit or system. The ASICs disclosed herein can be numerous types of devices such as processor integrated circuits, central processing units, memory integrated circuits, graphics processing unit integrated circuits, or application specific standard products (ASSPs).

The integrated circuits disclosed herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now described. Example 1 is a computer system for protecting an original circuit design for an integrated circuit, the computer system comprising: a logic circuit replacement tool for generating a redacted circuit design for the integrated circuit by replacing logic circuits in the original circuit design with configurable circuits that perform logic functions of the logic circuits when a bitstream stored in storage circuits configures the configurable circuits, wherein the logic circuit replacement tool causes the redacted circuit design to share a first bit in the bitstream between at least two of the configurable circuits by coupling a first one of the storage circuits that stores the first bit to a first input of each of the at least two of the configurable circuits.

In Example 2, the computer system of Example 1 may optionally include, wherein each of the at least two of the configurable circuits comprises a lookup table circuit, and wherein the first one of the storage circuits is coupled to a data input of a multiplexer circuit in the lookup table circuit in each of the at least two of the configurable circuits.

In Example 3, the computer system of any one of Examples 1-2 may optionally include, wherein the logic circuit replacement tool causes the redacted circuit design to share a second bit in the bitstream between the at least two of the configurable circuits by coupling a second one of the storage circuits that stores the second bit to a second input of each of the at least two of the configurable circuits.

In Example 4, the computer system of any one of Examples 1-3 may optionally include, wherein the logic circuit replacement tool refrains from replacing any of the logic circuits in the original circuit design with a lookup table circuit that only consists of a single select input.

In Example 5, the computer system of any one of Examples 1-4 may optionally include, wherein the logic circuit replacement tool refrains from replacing any of the logic circuits in the original circuit design with an additional configurable circuit having at least two inputs that are coupled to one of the storage circuits that stores a single bit in the bitstream.

In Example 6, the computer system of any one of Examples 1-5 may optionally include, wherein the logic circuit replacement tool refrains from replacing any of the logic circuits in the original circuit design with an additional configurable circuit that receives a reset signal at an input.

In Example 7, the computer system of any one of Examples 1-6 may optionally include, wherein the logic circuit replacement tool is configured to replace at least one of the logic circuits in the original circuit design with a lookup table circuit comprising at least three select inputs.

In Example 8, the computer system of any one of Examples 1-7 may optionally include, wherein the logic circuit replacement tool refrains from replacing any of the logic circuits in the original circuit design with one configurable circuit that receives bits in the bitstream in a first order and another configurable circuit that receives the bits in the bitstream in a second order that is permutated with respect to the first order.

Example 9 is a method for redacting an original circuit design for an application specific integrated circuit to generate a redacted circuit design, the method comprising: replacing logic circuits in the original circuit design with configurable circuits in the redacted circuit design that perform logic functions of the logic circuits when a bitstream stored in storage circuits configures the configurable circuits; and sharing a first bit in the bitstream between at least two of the configurable circuits in the redacted circuit design to cause the first bit in the bitstream to configure the at least two of the configurable circuits.

In Example 10, the method of Example 9 further comprises: sharing a second bit in the bitstream between the at least two of the configurable circuits in the redacted circuit design to cause the second bit in the bitstream to configure the at least two of the configurable circuits.

In Example 11, the method of any one of Examples 9-10 may optionally include, wherein replacing the logic circuits in the original circuit design with the configurable circuits further comprises: refraining from replacing any of the logic circuits in the original circuit design with an additional configurable circuit that only consists of a single select input.

In Example 12, the method of any one of Examples 9-11 may optionally include, wherein replacing the logic circuits in the original circuit design with the configurable circuits further comprises: refraining from replacing any of the logic circuits in the original circuit design with an additional configurable circuit having at least two inputs that receive a same configuration bit in the bitstream.

In Example 13, the method of any one of Examples 9-12 may optionally include, wherein replacing the logic circuits in the original circuit design with the configurable circuits further comprises: refraining from replacing any of the logic circuits in the original circuit design with an additional configurable circuit that receives a reset signal at an input.

In Example 14, the method of any one of Examples 9-13 may optionally include, wherein replacing the logic circuits in the original circuit design with the configurable circuits further comprises: replacing at least one of the logic circuits in the original circuit design with one of the configurable circuits that comprises at least three select inputs.

In Example 15, the method of any one of Examples 9-14 may optionally include, wherein replacing the logic circuits in the original circuit design with the configurable circuits further comprises: refraining from replacing the logic circuits in the original circuit design with an additional configurable circuit that receives configuration bits in the bitstream in a first order and another configurable circuit that receives the configuration bits in the bitstream in a second order that is different than the first order.

Example 16 is a non-transitory computer readable storage medium comprising instructions stored thereon for causing a computing system to execute a method for redacting an original circuit design for an application specific integrated circuit, the method comprising: generating options of different configurable circuits for replacing a logic circuit in the original circuit design; and selecting one of the different configurable circuits to replace the logic circuit in a redacted circuit design for the application specific integrated circuit, wherein one of the generating or selecting is performed using a random number.

In Example 17, the non-transitory computer readable storage medium of Example 16 may optionally include, wherein the method further comprises: generating the random number using key based variation.

In Example 18, the non-transitory computer readable storage medium of any one of Examples 16-17 may optionally include, wherein the random number is generated by a pseudo random number generator.

In Example 19, the non-transitory computer readable storage medium of any one of Examples 16-18 may optionally include, wherein generating the options of the different configurable circuits the for replacing the logic circuit comprises generating at least one of the different configurable circuits with an additional logic circuit and a multiplexer circuit that is configured to bypass the additional logic circuit.

In Example 20, the non-transitory computer readable storage medium of any one of Examples 16-19 may optionally include, wherein generating the options of the different configurable circuits for replacing the logic circuit comprises generating at least one of the different configurable circuits with circuitry that is unused in the redacted circuit design.

The foregoing description of the examples has been presented for the purpose of illustration. The foregoing description is not intended to be exhaustive or to be limiting to the examples disclosed herein. In some instances, features of the examples can be employed without a corresponding use of other features as set forth. Many modifications, substitutions, and variations are possible in light of the above teachings.

What is claimed is:

1. A computer system for protecting an original circuit design for an integrated circuit, the computer system comprising:
a logic circuit replacement tool for generating a redacted circuit design for the integrated circuit by replacing logic circuits in the original circuit design with configurable circuits that perform logic functions of the logic circuits when a bitstream stored in storage circuits configures the configurable circuits,
wherein the logic circuit replacement tool causes the redacted circuit design to share a first bit in the bitstream between at least two of the configurable circuits by coupling a first one of the storage circuits that stores the first bit to a first input of each of the at least two of the configurable circuits.

2. The computer system of claim 1, wherein each of the at least two of the configurable circuits comprises a lookup table circuit, and wherein the first one of the storage circuits is coupled to a data input of a multiplexer circuit in the lookup table circuit in each of the at least two of the configurable circuits.

3. The computer system of claim 1, wherein the logic circuit replacement tool causes the redacted circuit design to share a second bit in the bitstream between the at least two of the configurable circuits by coupling a second one of the storage circuits that stores the second bit to a second input of each of the at least two of the configurable circuits.

4. The computer system of claim 1, wherein the logic circuit replacement tool refrains from replacing any of the logic circuits in the original circuit design with a lookup table circuit that only consists of a single select input.

5. The computer system of claim 1, wherein the logic circuit replacement tool refrains from replacing any of the logic circuits in the original circuit design with an additional configurable circuit having at least two inputs that are coupled to one of the storage circuits that stores a single bit in the bitstream.

6. The computer system of claim 1, wherein the logic circuit replacement tool refrains from replacing any of the logic circuits in the original circuit design with an additional configurable circuit that receives a reset signal at an input.

7. The computer system of claim 1, wherein the logic circuit replacement tool is configured to replace at least one of the logic circuits in the original circuit design with a lookup table circuit comprising at least three select inputs.

8. The computer system of claim 1, wherein the logic circuit replacement tool refrains from replacing any of the logic circuits in the original circuit design with an additional configurable circuit that receives bits in the bitstream in a first order and another configurable circuit that receives the bits in the bitstream in a second order that is permutated with respect to the first order.

9. A method for redacting an original circuit design for an application specific integrated circuit to generate a redacted circuit design, the method comprising:
replacing logic circuits in the original circuit design with configurable circuits in the redacted circuit design that perform logic functions of the logic circuits when a bitstream stored in storage circuits configures the configurable circuits; and
sharing a first bit in the bitstream between at least two of the configurable circuits in the redacted circuit design to cause the first bit in the bitstream to configure the at least two of the configurable circuits.

10. The method of claim 9 further comprising:
sharing a second bit in the bitstream between the at least two of the configurable circuits in the redacted circuit design to cause the second bit in the bitstream to configure the at least two of the configurable circuits.

11. The method of claim 9, wherein replacing the logic circuits in the original circuit design with the configurable circuits further comprises:
refraining from replacing any of the logic circuits in the original circuit design with an additional configurable circuit that only consists of a single select input.

12. The method of claim 9, wherein replacing the logic circuits in the original circuit design with the configurable circuits further comprises:
refraining from replacing any of the logic circuits in the original circuit design with an additional configurable circuit having at least two inputs that receive a same configuration bit in the bitstream.

13. The method of claim 9, wherein replacing the logic circuits in the original circuit design with the configurable circuits further comprises:
refraining from replacing any of the logic circuits in the original circuit design with an additional configurable circuit that receives a reset signal at an input.

14. The method of claim 9, wherein replacing the logic circuits in the original circuit design with the configurable circuits further comprises:
replacing at least one of the logic circuits in the original circuit design with one of the configurable circuits that comprises at least three select inputs.

15. The method of claim 9, wherein replacing the logic circuits in the original circuit design with the configurable circuits further comprises:
refraining from replacing the logic circuits in the original circuit design with an additional configurable circuit that receives configuration bits in the bitstream in a first order and another configurable circuit that receives the configuration bits in the bitstream in a second order that is different than the first order.

16. A non-transitory computer readable storage medium comprising instructions stored thereon for causing a computing system to execute a method for redacting an original circuit design for an application specific integrated circuit, the method comprising:
generating options of different configurable circuits for replacing a logic circuit in the original circuit design; and
selecting one of the different configurable circuits to replace the logic circuit in a redacted circuit design for the application specific integrated circuit, wherein one of the generating or the selecting is performed using a random number.

17. The non-transitory computer readable storage medium of claim 16, wherein the method further comprises:
generating the random number using key based variation.

18. The non-transitory computer readable storage medium of claim 16, wherein the random number is generated by a pseudo random number generator.

19. The non-transitory computer readable storage medium of claim 16, wherein generating the options of the different configurable circuits for replacing the logic circuit comprises generating at least one of the different configurable circuits with an additional logic circuit and a multiplexer circuit that is configured to bypass the additional logic circuit.

20. The non-transitory computer readable storage medium of claim 16, wherein generating the options of the different configurable circuits for replacing the logic circuit comprises generating at least one of the different configurable circuits with circuitry that is unused in the redacted circuit design.
